(19) United States
(12) Patent Application Publication
(10) Pub. No.: US 2020/0125078 A1
(43) Pub. Date: Apr. 23, 2020

(54) METHOD AND SYSTEM FOR ENGINEER-TO-ORDER PLANNING AND MATERIALS FLOW CONTROL AND OPTIMIZATION

(71) Applicant: General Electric Company, Schenectady, NY (US)

(72) Inventors: Peter KOUDAL, Niskayuna, NY (US); Walter YUND, Clifton Park, NY (US); Annarita GIANI, Niskayuna, NY (US); Dan YANG, Clifton Park, NY (US); Benjamin BECKMANN, Niskayuna, NY (US); Joseph SALVO, Schenectady, NY (US); John William CARBONE, Ballston Spa, NY (US); Patricia MACKENZIE, Clifton Park, NY (US)

(21) Appl. No.: 16/165,333

(22) Filed: Oct. 19, 2018

(51) Int. Cl. G05B 19/418

(52) U.S. Cl. CPC G05B 19/41865; G05B 2219/42155; G05B 2219/31376

(57) ABSTRACT

According to some embodiments, system and methods are provided, comprising a flow module to receive one or more objectives for a flow in the production of an object; a memory for storing program instructions; a flow processor, coupled to the memory, and in communication with the flow module and operative to execute program instructions to: receive a request from a user for a current state of a flow for the object; retrieve metadata and data from the physical world associated with the object; determine a current phase in the flow for the object; select an analytic model to determine the current state of the flow for the object; instantiate a digital twin for the current phase in the flow for the object; execute the selected analytic for the instantiated digital twin; generate a response to the request including the current state of the flow for the object based on the executed analytic; and display the response on a display. Numerous other aspects are provided.

### BACKGROUND

In a standard product supply chain, a product is based on a standard design and standard parts. With so many standard aspects, the operations in different areas in the supply chain may be managed by an overall product-level control. In an engineer-to-order supply chain, on the other hand, there may be multiple entities managing within their own area, and there may be little or no end-to-end control and visibility to the state of the overall system.

It would be desirable to provide systems and methods to improve the flow control and optimization in an engineer-to-order supply chain.

### BRIEF DESCRIPTION

According to some embodiments, a computer implemented method includes receiving a request from a user for a current state of a flow for the object; retrieving metadata and data from the physical world associated with the object; determining a current phase in the flow for the object; selecting an analytic model to determine the current state of the flow; instantiating a digital twin for the current phase in the flow; executing the selected analytic for the instantiated digital twin; generating a response to the request including the current state of the flow for the object based on the executed analytic; and displaying the response on a display.

According to some embodiments, a system includes a flow module to receive one or more objectives for a flow in the production of an object; a memory for storing program instructions; a flow processor, coupled to the memory, and in communication with the flow module and operative to execute program instructions to: receive a request from a user for a current state of a flow for the object; retrieve metadata and data from the physical world associated with the object; determine a current phase in the flow for the object; select an analytic model to determine the current state of the flow for the object; instantiate a digital twin for the current phase in the flow for the object; execute the selected analytic for the instantiated digital twin; generate a response to the request including the current state of the flow for the object based on the executed analytic; and display the response on a display.

According to some embodiments, a non-transitory, computer-readable medium storing instructions that, when executed by a computer processor, cause the computer processor to perform a method comprising: receiving a request from a user for a current state of a flow for the object; retrieving metadata associated with the object; determining a current phase in the flow for the object; selecting an analytic model to determine the current state of the flow; instantiating a digital twin for the current phase in the flow; executing the selected analytic for the instantiated digital twin; generating a response to the request including the current state of the flow for the object based on the executed analytic; and displaying the response on a display.

A technical effect of some embodiments of the invention is an improved and/or computerized technique and system for reviewing, controlling and optimizing operations for the different areas in the supply chain while automatically sharing a current state of the entire supply chain with different parts of the chain. One or more embodiments provide for complex data modeling and integration across an end-to-end supply chain for an engineer-to-order product from order to delivery. One or more embodiments provide for real-time optimization of decision making for physical parts, sub-systems, and system flow and state of materials and products. One or more embodiments may provide for decreased cycle time and reduced lead times through more efficient engineer-to-order and order-to-delivery processes and material flows. Inventory of raw materials, parts, and sub-systems may be reduced, which may reduce cost and cash outlays. One or more embodiments may provide for improved on-time delivery of raw materials and sub-systems as well as finished goods to customers. Embodiments may also provide for improved throughput time in manufacturing, assembly and final assembly (packaging) and test operations to reduce cost and improve capacity of the system. Other real-world benefits include increased customer satisfaction through better prediction of product delivery to meet customer requirement dates per one or more embodiments.

With this and other advantages and features that will become hereinafter apparent, a more complete understanding of the nature of the invention can be obtained by referring to the following detailed description and to the drawings appended hereto.

Other embodiments are associated with systems and/or computer-readable medium storing instructions to perform any of the methods described herein.

### DRAWINGS

FIG. 1 illustrates a system according to some embodiments.

FIG. 2 illustrates a block diagram according to some embodiments.

FIG. 3 illustrates a flow diagram according to some embodiments.

FIG. 4 illustrates a chart according to some embodiments.

FIGS. 5A-5C illustrate a model according to some embodiments.

FIGS. 6A-6B illustrate a model according to some embodiments.

FIGS. 7A-7B illustrate a user interface according to some embodiments.

FIGS. 8A-8B illustrate a user interface according to some embodiments.

FIG. 9 illustrates a block diagram of a system according to some embodiments.

### DETAILED DESCRIPTION

In an engineer-to-order supply chain or flow, an order is first received from a customer. As used herein, the terms “flow” and “supply chain” may be used interchangeably. For example, a gas company wants to build a gas field in Australia, and they place an order for a specific natural gas compressor and gas turbine that targets exactly the conditions on the site in Australia. To develop this product, there may be a lot of designing related to pressure needed by the product, power needed by the product and modularity of components to transfer them to the site, as well as other aspects. This design may be managed by an engineering phase. Then, after the design is confirmed, the design is divided into the steps to actually manufacture the product. For example, a planning phase may determine what pieces will be manufactured in-house and which pieces will be sourced from outside sources. The planning phase may also determine who needs to deliver what item to whom and when it should be delivered. From the planning phase, the sourcing phase may then determine who they may make a contract with for a particular item, how much they need to order, and when and where the delivery of the order should take place, etc. Each of these different phases may include its own sub-system for managing its process. Each phase and sub-system within the phase may not be coordinated with each other. With each successive level or sub-system, the overall engineer-to-order flow increases in complexity. Further, when there is a problem with one aspect, the entire project of producing the product may be delayed, which may be very costly. It is further noted that, conventionally, optimal decisions may not be made for each phase of the process with respect to the overall system, as it may take weeks or months to gather the information from the disconnected phases and sub-systems to make a decision, and by the time the decision is made, it may be outdated.

As used herein, the terms “product” and “object” may be used interchangeably; and the terms “stage” and “phase” may be used interchangeably.

In one or more embodiments, based on the phase of the project, and the status for a material in that project, a flow module may select an analytic model from a catalog of models to apply to the data for that phase (project and material) to determine the state of the material (e.g., whether the material will be available, when it will be available, and if this availability is in a time frame to successfully complete the project in the desired time). In one or more embodiments, the flow module may select an analytic for a particular phase of data, as well as an analytic to provide an overview of the entire project, such that the flow module may output an overall timing status of every aspect of the process. As a non-exhaustive example, if a material needs to be produced by a manufacturing phase, an analytic model may be used to review manufacturing lead times to determine a completion date for the material, so that the system may then determine whether production of the material is late or not. If, instead of producing the material by the manufacturing phase, the material is sourced by a vendor, another analytic model may be used to determine if a request for the material has been sent to the vendor. If the request has not yet been sent, another analytic model may be used to determine how long it may take to issue the request for the material, and then receive the material. In one or more embodiments, both the analytic models for the manufactured material and sourced material may include a criticality aspect for the material. The analytic model for the sourced material may also include data about the particular vendor (e.g., risks associated with this vendor e.g., the vendor may indicate they will provide the material on time, but historically, this vendor provides the material one or more weeks late).

In one or more embodiments, the flow module generates a contextual digital twin for each phase of a project and the state and movement of materials as well as an integrated digital twin of all the contextual digital twins to determine the overall state of the systems. The contextual digital twins and integrated digital twin may allow analytic models to generate an optimal decision for each context with respect to the system. For instance, if a supplier is going to be late in delivering certain materials to the project, then the system may suggest delaying manufacturing of associated parts so that they are not built too early and simply put in inventory, thus avoiding adding unnecessary inventory holding costs to the project and optimizing the cost of the project. In one or more embodiments, the flow module may analyze metadata associated with each individual contextual digital twin and output an overall timing state for the project per an integrated digital twin. The flow module may, in one or more embodiments, analyze a capability of each of the contextual digital twins to understand what an optimal time frame is for that phase. The flow module may output whether the phase is operating on time; if it's late, how late is it, and how the lateness affects other aspects of the integrated twin.

While the examples herein are described in terms of a single project (i.e., production of an object to a ready-to-ship state) for ease of explanation, one or more embodiments provide for a system that is managing the flow of multiple projects at a same time, and the multiple projects may impact the same resources across the supply chain.

As used herein, the term “automatically” may refer to, for example, actions that may be performed with little or no human interaction.

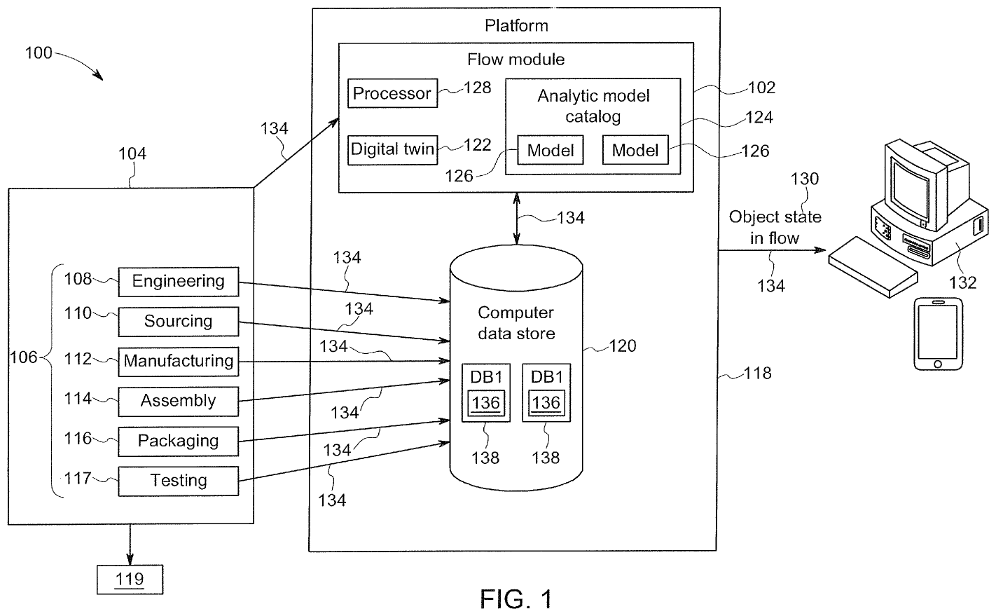

FIG. 1 is a block diagram of an example operating environment or system 100 in which a flow module 102 may be implemented, arranged in accordance with at least one embodiment described herein. FIG. 1 represents a logical architecture for describing processes according to some embodiments, and actual implementations may include more or different components arranged in other manners.

The system 100 may include at least one “project” 104. As used herein, “project” may refer to production of an object, which may be processed in multiple phases and assembled from multiple objects, to a ready-to-ship state. While one project 104 is shown herein, any suitable number may be used. Each project 104 may include several phases 106, including but not limited to an engineering phase 108, a sourcing phase 110, a manufacturing phase 112, an assembly phase 114, a packaging phase 116 and a testing phase 117. It is noted that each phase 106 communicates with a platform 118, and elements thereof, in a same manner, as described below. It is noted that production of the object 119 may include a considerable (or even very large) number of physical elements or items. The object 119 may also include subsystems, such as sensing and localized control, in one or more embodiments.

In some embodiments, the platform 118 may include a computer data store 120 that may provide information to the flow module 102 and store results from the flow module 102. The flow module 102 may include at least one digital twin 122, an analytic model catalog 124 including one or more analytic models 126, and one or more processing elements 128.

The processor 128 may, for example, be a conventional microprocessor, and may operate to control the overall functioning of the flow module 102. In one or more embodiments, the processor 128 may be programmed with a continuous or logistical model of one or more processes that are used in the production of the object 119.

With respect to the digital twin 122, “digital twin” state estimation modeling of the flow associated with production of an object (e.g., natural gas compressor) may estimate an optimal operating condition, operating performance such as lead time state or other metric, of a twinned physical system using sensors, communications, modeling, history and computation. It may provide an answer in a time frame that is useful, that is, meaningfully priori to a suboptimal operation. The operation may be provided by a “digital twin” of a twinned physical system. The digital twin 122 may be a computer model that virtually represents the state of system or one of the context/phases of the system. The digital twin 122 may include a code object with parameters and dimensions of its physical twin's parameters and dimensions that provide measured values, and keeps the values of those parameters and dimensions current by receiving and updating values via outputs from the physical twin. The digital twin may have respective virtual components that correspond to essentially all physical and operational components of the process for producing the object.

As used herein, references to a “digital twin” should be understood to represent one example of a number of different types of modeling that may be performed in accordance with teachings of this disclosure.

The flow module 102, according to some embodiments, may access the computer data store 120 and then utilize the digital twin 122 to create a prediction and/or result (e.g., a predicted completion time for a phase) that may be used by the flow module 102 to modify any of the phases in the production process or provide predicted timing status information to a user or another system. For example, in one or more embodiments, the flow module 102 may simulate (e.g., via the digital twin 122) a manufacturing phase 112 with a particular objective. It is noted that the digital twin 122 may enable the system 100 to customize the model 126 of the system or subsystems to a particular phase, making the output of the model more effective. As a non-exhaustive example, the digital twin 122 may include, e.g., a machine learning component to predict the future state of the system. In one or more embodiments, digital twin 122 may be used to estimate unmeasurable system states, and may estimate system and/or subsystem features. The estimates may be used to generate suggestions for operation of the phase in a manner that better meets the objectives (e.g., optimizes a cost of the project, optimizes a delivery date, etc.).

The data store 120 may comprise any one or more systems that store data that may be used by the module. The data stored in data store 120 may be received from disparate hardware and software systems associated with the phases 106, or otherwise, some of which are not inter-operational with one another. The systems may comprise a back-end data environment employed in a business, industrial, or personal context. The data may be pushed to data store 120 and/or provided in response to queries received therefrom.

In one or more embodiments, the data store 120 may comprise any combination of one or more of a hard disk drive, RAM (random access memory), ROM (read only memory), flash memory, etc. The data store 120 may store software that programs the processor 128 and the flow module 102 to perform functionality as described herein.

The data store 120 may support multi-tenancy to separately support multiple unrelated clients by providing multiple logical database systems which are programmatically isolated from one another.

The data may be included in a relational database, a multi-dimensional database, an eXtendable Markup Language (XML) document, and/or any other structured data storage system. The physical tables of data store 120 may be distributed among several relational databases, multi-dimensional databases, and/or other data sources. The data of data store 120 may be indexed and/or selectively replicated in an index.

The data store 120 may implement as an “in-memory” database, in which volatile (e.g., non-disk-based) storage (e.g., Random Access Memory) is used both for cache memory and for storing data during operation, and persistent storage (e.g., one or more fixed disks) is used for offline persistency of data and for maintenance of database snapshots. Alternatively, volatile storage may be used as cache memory for storing recently-used database data, while persistent storage stores data. In some embodiments, the data comprises one or more of conventional tabular data, row-based data stored in row format, column-based data stored in columnar format, time series data in a time series data store, and object-based data. Data store 120 may store data used by applications. The data store may comprise any query-responsive data source or sources that are or become known, including but not limited to a structured-query language (SQL) relationship.

The flow module 102, according to some embodiments, may access the data store 120 and utilize the digital twin 122, one or more models 126 of the analytic model catalog 124 and processing elements 128 to distribute a current timing state analysis (e.g., object state in the flow) 130 regarding the production of the object. In one or more embodiments, the current timing state analysis may include the phase of production for the object and the state/alert level for that that phase, and a state/alert level for the entire project. In one or more embodiments, the current timing state analysis 130 may be transmitted to various user platforms 132 or to other systems (not shown), as appropriate (e.g., for display to, and manipulation by, a user). In one or more embodiments, the current timing state analysis 130 may be used to operate one or more aspects of the phase (e.g., modify when a part for a first project gets manufactured compared to a part for another project), operate another system, or as input to another system.

A communication channel 134 may be included in the system 100 to supply input from at least one of the phases 106 and the data store 120 to the flow module 102.

In some embodiments, the system 100 may also include a communication channel 134 to supply output (e.g., the timing status/analysis) from the flow module 102 to at least one of: user platforms 132, or to other systems. In some embodiments, received timing status/analyses may cause modification in the state or condition or another attribute of the phases for producing the object.

As used herein, devices, including those associated with the system 100 and any other devices described herein, may exchange information and transfer input and output (“communication”) via any number of different systems. For example, wide area networks (WANs) and/or local area networks (LANs) may enable devices in the system to communicate with each other. In some embodiments, communication may be via the Internet, including a global internetwork formed by logical and physical connections between multiple WANs and/or LANs. Alternately, or additionally, communication may be via one or more telephone networks, cellular networks, a fiber-optic network, a satellite network, an infrared network, a radio frequency network, any other type of network that may be used to transmit information between devices, and/or one or more wired and/or wireless networks such as, but not limited to Bluetooth access points, wireless access points, IP-based networks, or the like. Communication may also be via servers that enable one type of network to interface with another type of network. Moreover, communication between any of the depicted devices may proceed over any one or more currently or hereafter-known transmission protocols, such as Asynchronous Transfer Mode (ATM), Internet Protocol (IP), Hypertext Transfer Protocol (HTTP) and Wireless Application Protocol (WAP).

A user may access the system 100 via one of the user platforms 132 (a control system, a desktop computer, a laptop computer, a personal digital assistant, a tablet, a smartphone, etc.) to view information about and/or manage the phases 106 in accordance with any of the embodiments described herein.

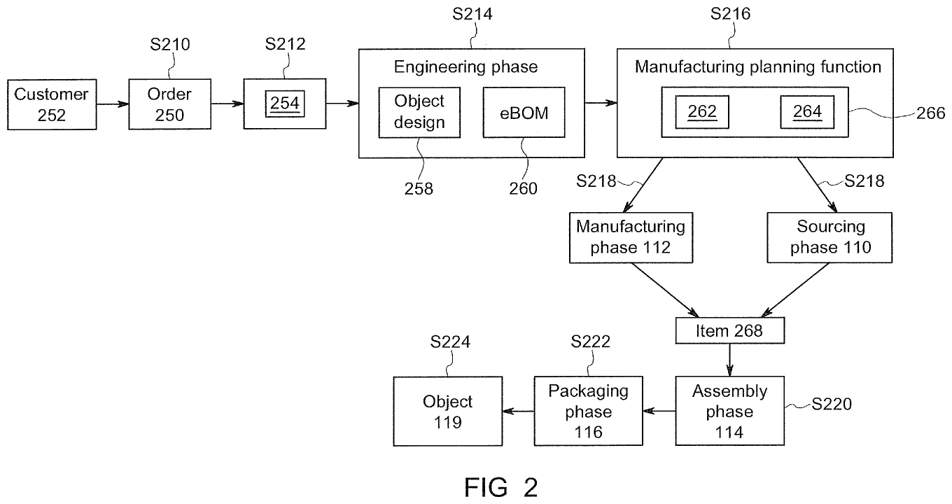

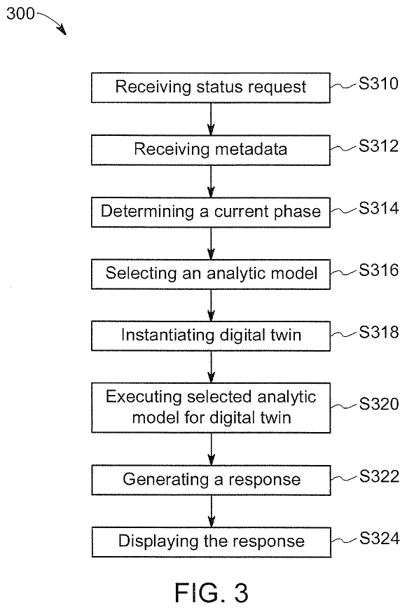

Turning to FIGS. 2-8, flow diagrams 200, 300 (FIGS. 2 and 3) and associated diagrams, of an example of operation according to some embodiments is provided. In particular, FIGS. 2, 3 provide a flow diagram of a process 200, 300, according to some embodiments. Processes 200, 300, and any other process described herein, may be performed using any suitable combination of hardware (e.g., circuit(s)), software or manual means. For example, a computer-readable storage medium may store thereon instructions that when executed by a machine result in performance according to any of the embodiments described herein. In one or more embodiments, the system 100 is conditioned to perform the processes 200, 300 such that the system is a special-purpose element configured to perform operations not performable by a general-purpose computer or device. Software embodying these processes may be stored by any non-transitory tangible medium including a fixed disk, a floppy disk, a CD, a DVD, a Flash drive, or a magnetic tape. Examples of these processes will be described below with respect to embodiments of the system, but embodiments are not limited thereto. The flow chart(s) described herein do not imply a fixed order to the steps, and embodiments of the present invention may be practiced in any order that is practicable.

Initially, at S210, an order 250 is received at the system 100 from a customer 252 for a build-to-order object (“object”) 119. In one or more embodiments, the customer may inquire about the build-to-order object 119, and a contract for the object may be signed. The object 119 may be assigned a project identifier 254 (e.g. any suitable alpha-numeric identifier) in S212. Then, in S214, the engineering phase 108 may create an object design 258 and create an electronic Bill of Materials (BOM) 260 of the object 119 and its component parts.

Next, in S216, a manufacturing planning function may create a manufacturing BOM 262 and a schedule 264. In one or more embodiments, the manufacturing BOM 262 may indicate whether each component of the object is to be manufactured or purchased from a supplier. It is noted that each object may be made from multiple items or components, where each item may each have its own set of items. For example, when the object is a natural gas compressor, an item may be a piston or a shaft, which in turn may have a plurality of items (e.g., rings, seals, etc.).

The schedule 264 may include one or more schedule dates and/or promised dates that may be received by the system prior to generation of the schedule. In one or more embodiments, the scheduled dates, which are the delivery dates required for each process step to finish on time determined by the manufacturing planning function, may include an operational sequence of dates, a resource operation code, and a setup time; while the promised dates may include a working time, an operation spent time, operation remaining time and operation status provided by the supplier of the items, such as an outside supplier or an internal sub-assembly operation. In one or more embodiments, the schedule 264 may also include one or more lead times for each phase of the process, determined by the manufacturing planning function, which the system 100 may also receive.

In one or more embodiments, the manufacturing BOM 262 and the schedule 264 may together form a “planned order” 266. The manufacturing planning function may then indicate to each of the sourcing phase 110 and the manufacturing phase 112, in S218, the project id and the items 268 each phase is responsible for providing, as well as the schedule. When each of the sourcing phase 110 and the manufacturing phase 112 is able to provide the component they are responsible for, the component is provided to the assembly phase 114 in S220. In the assembly phase 114, the components that may be assembled for shipping are assembled. For example, while the natural gas compressor system may include a motor, the motor may be coupled to the compressor at the assembly site. The assembled components may then be packaged in the packaging phase 116 in S222. In one or more embodiments, the assembled components may be packaged on a skid or some other suitable pallet for delivery in the packaging phase 116. After the assembled components are packaged, the project may be considered complete, in one or more embodiments, and may then be delivered to the contract location in S224.

After the project is received in the system (S210) and assigned the identifier 254 (S212), a user may submit a query to determine a current state of the project with respect to a process flow, or supply chain.

Prior to the start of process 300, the system 100 may receive one or more objectives for a flow in the production of the object. In one or more embodiments, the system may include a default objective to provide the object by the scheduled date or beforehand in an efficient manner.

Initially, at S310, a request for at least one of a current state and a desired future state of the project with respect to the process flow is received from a user. As used herein “current state” may refer to the current phase or context of the project, as well as the timing or alert level within that phase, and in relation to other phases in the project (e.g., if the phase is operating on time; if it's late, how late is it, and how the lateness affects other aspects of the project). Then in S312, metadata 136 and data from the physical world associated with the object 119 is received. Data from the physical world may be, as a non-exhaustive example, inventory data regarding physical objects (parts, materials) on shelves in a warehouse, on pallets in receiving inventory, etc. In one or more embodiments, the metadata 136 may be retrieved from one or more databases 138. The databases 138 may receive metadata data from the one or more phases 106. The data received in S312 may be received from two or more disconnected databases. In one or more embodiments, the databases 138 may receive the metadata as a result of at least one of a pull or push process, whereby data receipt is initiated by the flow module 102 (“pull process”) or data receipt is initiated by the phases 106 (“push process”). The metadata may be received periodically or in response to a request.

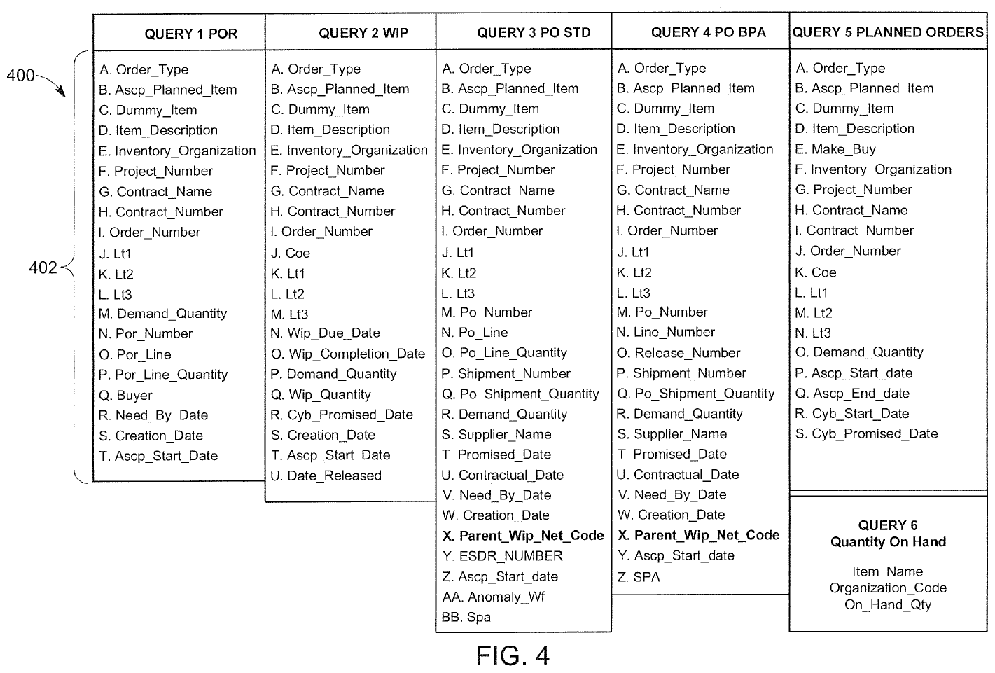

Turning to FIG. 4, a chart 400 showing fields 402 of data received from different phases is provided, according to one or more embodiments. Other suitable categories may be used. In the non-exhaustive example shown here, the data receipt was initiated by the flow module 102 in the form of queries to databases about each of the phases, as indicated by “Query 1,” “Query 2,” “Query 3”, etc. For example “Query 1” was sent to the sourcing phase 110 for a “purchase order requisition” (POR), “Query 2” was sent to the manufacturing phase 112 for a “Work in Progress” (WIP), “Query 3” was sent to the sourcing phase 110 for a “Purchase order standard” (PO STD), “Query 4” was sent to the sourcing phase 110 for a “Blanked Purchase Order Agreement” (PO BPA), “Query 5” was sent to the manufacturing phase 112 for a “Planned Order”, and “Query 6” was sent to the manufacturing phase 112 for “Quantity on Hand”. It is noted each phase 106 may include one or more sub-phases, which may result in more than one query being sent to a particular phase.

Each query may return data values for one or more fields 402.

Next, in S314, a current phase in the flow for the object 119 is determined. In one or more embodiments, the flow module 102 may analyze the returned data (e.g., values for fields 402 in chart 400) to determine which query returned a value in the “order type” field 402. The phase associated with the query furthest along in the flow that includes a value in the “order type” field 402 is the current phase. For example, if the purchase order needs to be replaced, via POR, for a particular object, data may be returned for Query 1, but not for Query 4 because the order has not been placed yet.

Then, in S316, an analytic model 126 is selected to determine at least one of the current state and desired future state of a flow for the object 119. In one or more embodiments, based on a particular phase of a project (and, in some instances, a particular phase of a material in the project), the flow module 102 may determine a particular analytic model 126 to apply to determine the state, at least one of a current state or a desired future state (e.g., whether the material will be available, the date the material will be available, and whether this date is in a suitable time frame to make the project successful). As used herein, the “desired future state” may relate to the desired time a current or future activity (process) may be finished. By knowing the current delay on one activity and the potential impact it may have on the multiple processes in the future, resources may be directed to address the most important delays. The selection may also be based on the determined current phase in the flow for production of the object in a context of an order type. A non-exhaustive list of analytic models may include a sourcing/buying-PO Issuing status model, a supplier order status model, an engineering status model, a real item issuing delay model, a project start and completion date model, a critical item status model, a supplier status model, a job report mode, a critical item report model, etc. The analytic model 126 may be selected based on the order type. It is noted that the analytic model may be selected based on other criteria. As a non-exhaustive example, the analytic model may be selected based on optimizing a more precise delivery time estimate. In one or more embodiments, the analytic model 126 may be selected from a catalog of analytic models 124. In one or more embodiments, the catalog 124 may be populated with one or more analytic models provided by a developer or administrator during development and/or execution of the phases of the supply chain.

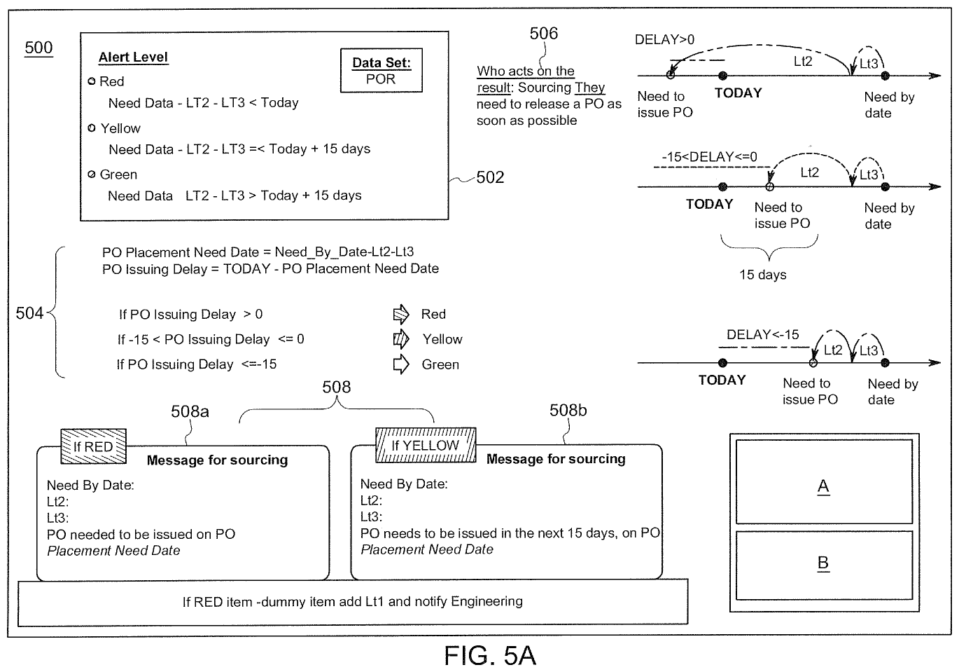

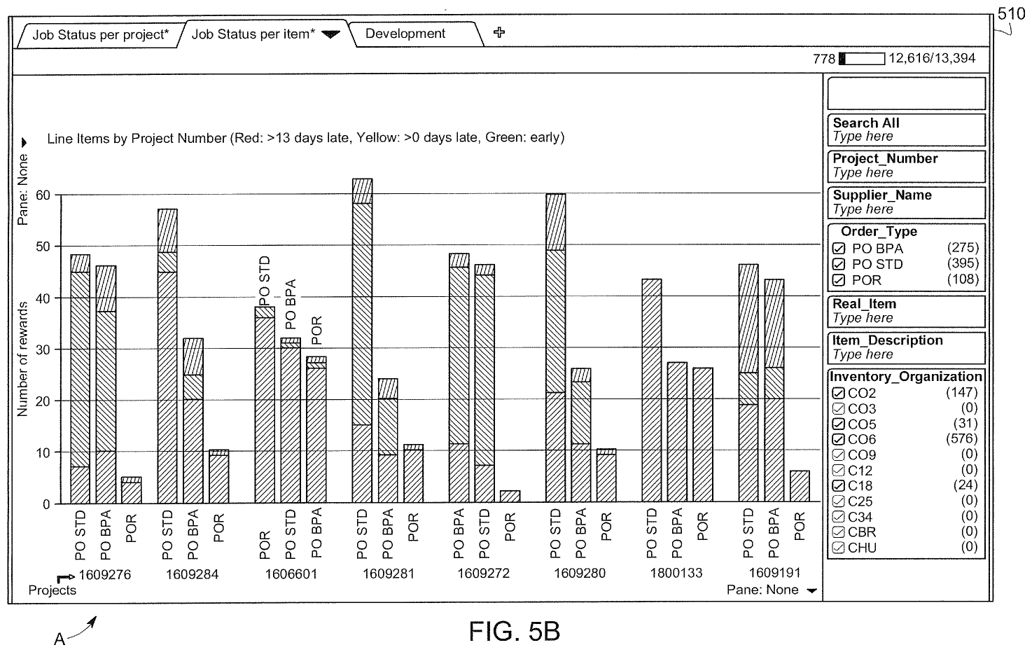

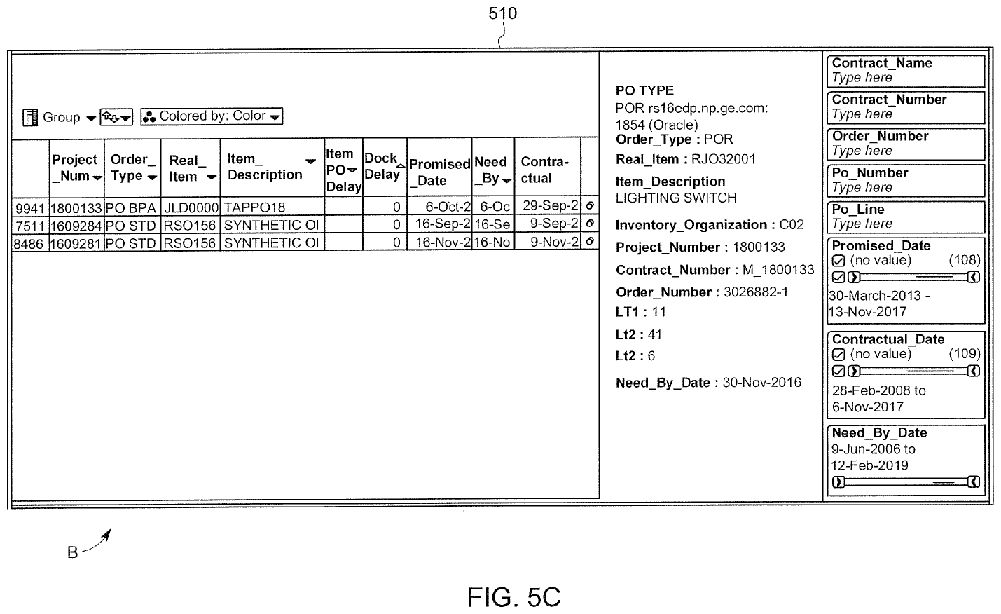

Turning to FIGS. 5A-5C, and continuing with the non-exhaustive example described above, for the placement of the purchase order, an analytic model 500 may be selected to determine whether the purchase order should be issued now, in the future, or in the past.

When items for the object are being sourced by an outside supplier, they may need to be ordered via a purchase order. In this instance, the items have not been ordered yet. The analytic model 500 selected herein may use lead time (LT) (e.g., how long it will take the supplier to provide the item) data provided by the supplier or from estimates based on historical data, as well as other information (e.g., when the item needs to be received by, how long it will take to process the purchase order once the purchase order is generated, and how long it takes to generate the purchase order, etc.). While the lead times shown in FIGS. 5A-5C are for issuing and fulfilling the purchase order, for another analytic model, the lead time may indicate another variable (e.g., how long to manufacture the item).

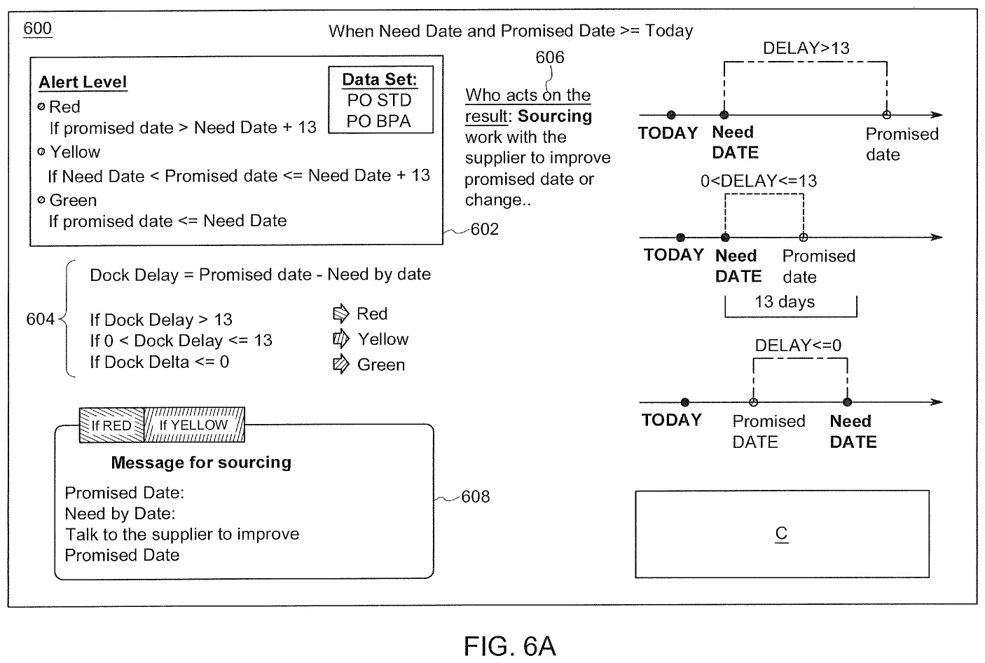

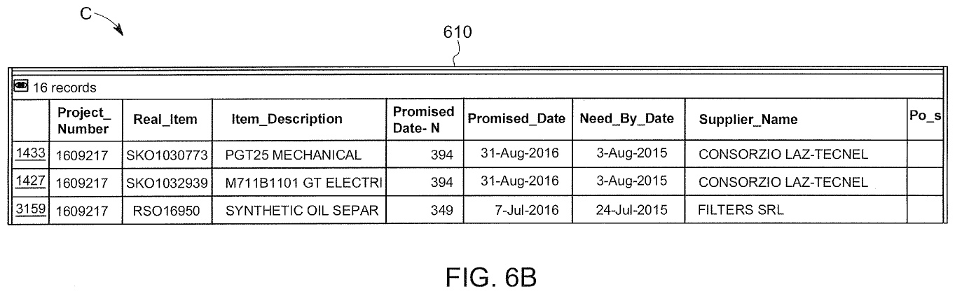

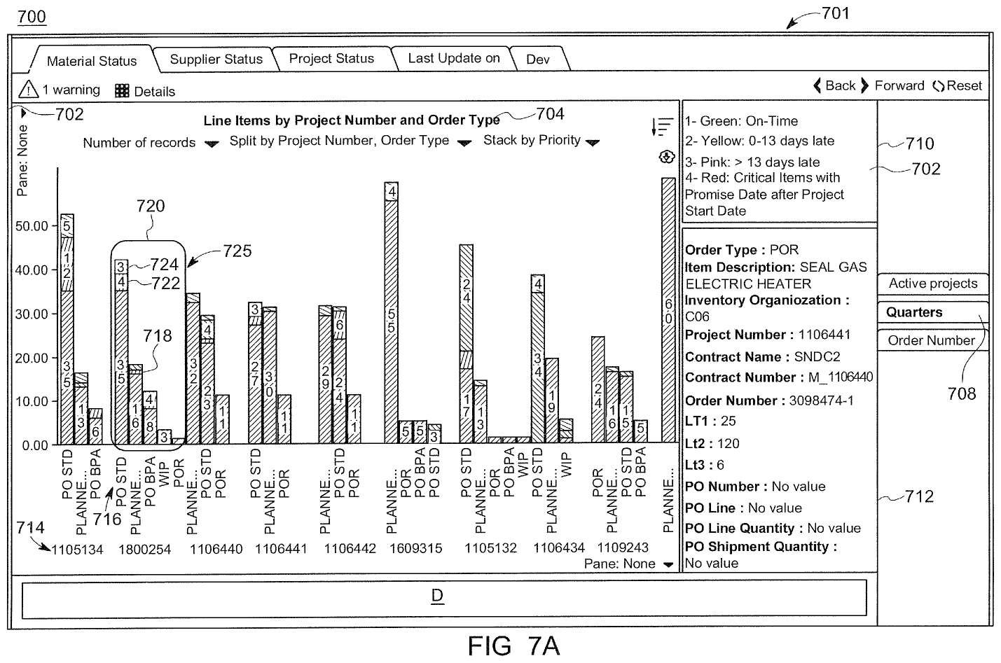

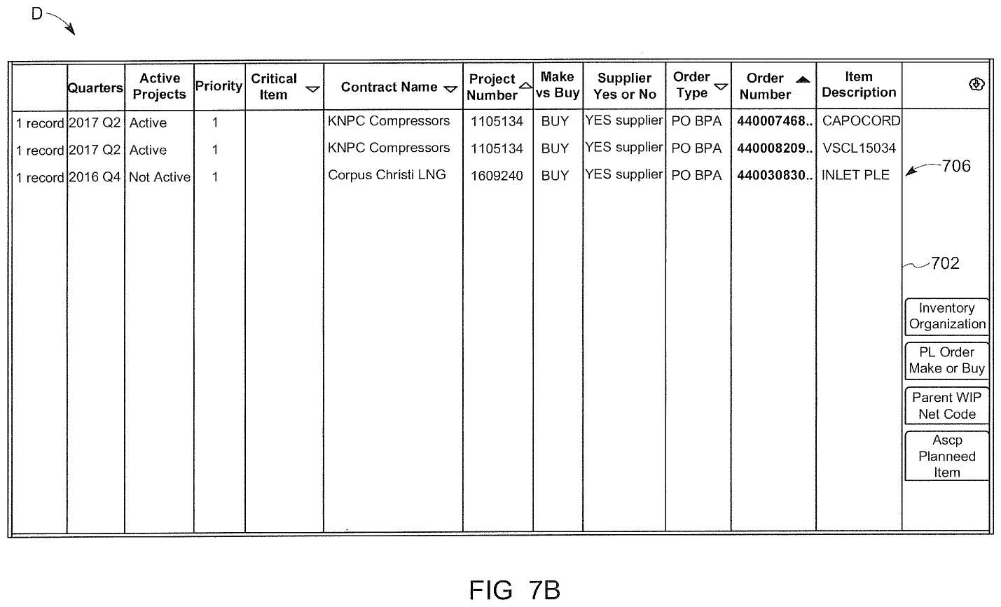

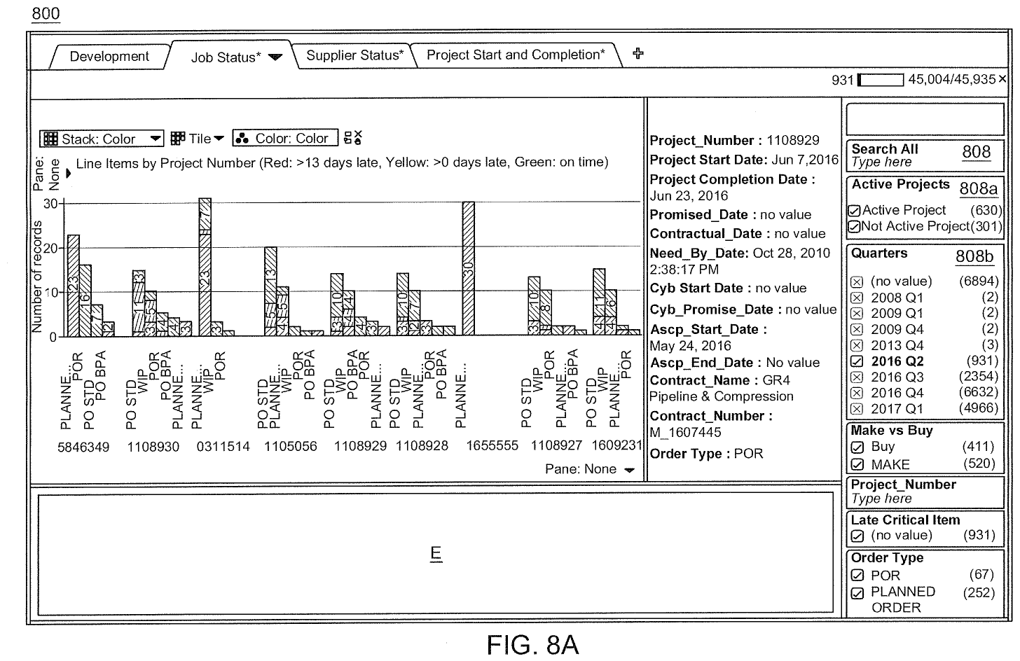

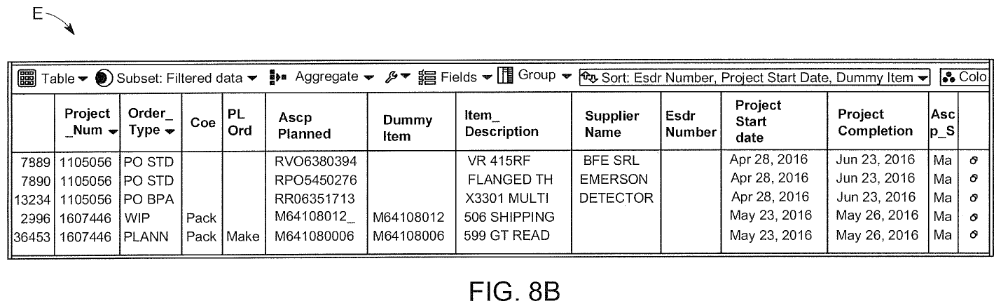

A description of the analytic model is shown in FIGS. 5A-5C. The analytic model 500 may include an alert level key 502 that indicates the criticality of the output of the model. For example, when the analytic model 500 outputs a date where the Need Date-LT2-LT3<Today, the level may be critical, and may, in some embodiments, be indicated by a particular color (e.g., red). This Need Date is the date the material is required by the project to proceed with assembly and/or packaging. If, instead, the analytic model 500 outputs a date where the Need Date-LT2-LT3=<Today+15 days, the level may not be critical yet, but may need to be attended to soon. When the analytic model 500 outputs a date where the Need Date-LT2-LT3>Today+15 days, the level is not critical. In one or more embodiments, the criticality of the level may be indicated via a color or other visual indicator (e.g., red for critical, yellow for soon to be critical, green for not critical). It is noted that output from the model (e.g., message 508 and status UI 510 shown in FIGS. 5A-5C, and message 608 and status UI 610 shown in FIG. 6) may be viewable by the user, with the criticality level visually indicated. The analytic model 500 may be configured with one or more rules 504 that may indicate which alert level is output. In the non-exhaustive example herein, the rules 504 may include, but are not limited to, “PO Placement Need Date=Need_By_Date-Lt2-Lt3,” “PO Issuing Delay=TODAY-PO Placement Need Date,” “If PO issuing Delay>0→Red,” “If −15<PO Issuing Delay<=0→Yellow,” “If PO Issuing Delay<=−15→Green.” The model 500 may include a “Who acts on the result” field 506, which may indicate the phase and/or party that may receive an output from the executed analytic model 500. In the non-exhaustive example shown herein, “sourcing” is the value in the “who acts on the result” field 506. In one or more embodiments, a message 508 may be transmitted to the phase listed in the “who acts on the result” field 506. For example, when the output is red, the message 508a may include a need by date, an Lt2, an Lt3, and the phrase “PO needed to be issued on PO Placement Need Date.” As another example, when the output is yellow, the message 508b may include a need by date, an Lt2, an Lt3, and the phrase “PO needs to be issued in the next 15 days, on PO Placement Need Date.” In one or more embodiments, the output from the analytic model 500 (e.g., state or alert level for the object or items thereof as shown in 510) may be transmitted to a user interface 700, described further below with respect to FIGS. 7 and 8. In the example described in FIGS. 5A-5C herein, the output 510 or response may be a supplier order and PO issuing status per project.

Turning to FIGS. 6A-6B, an example of an analytic model 600 associated with Query 3 and Query 4 (the sourcing phase 110) is provided. This non-exhaustive example relates to a supplier providing the ordered element. The analytic model 600 includes an alert level key 602. For example, when the analytic model 600 outputs a date where the Promised date>Need Date+13, the level may be critical, and may, in some embodiments, be indicated by a particular color (e.g., red). Promise Date is the data the supplier has agreed to deliver the item. It may be earlier, the same or later than the Need Date, which is when the project needs the item delivered. If, instead, the analytic model 600 outputs a need date<Promised date<=Need Date+13, the level may not be critical yet, but may need to be attended to soon. When the analytic model 600 outputs a date where the promised date<=Need Date, the level is not critical. The analytic model 600 may be configured with one or more rules 604 that may indicate which alert level is output. In the non-exhaustive example herein, the rules 604 may include, but are not limited to, “Dock Delay=Promised date=Need by date”, “If Dock Delay>13→Red,” “If 0<Dock Delay<=13→Yellow,” and “If Dock Delay<=0→Green.” The analytic model 600 may include a “Who acts on the result” field 606. In the non-exhaustive example shown herein, “Sourcing” is the value in the “who acts on the result” field 606, as the Sourcing phase 110 may work with the supplier to improve a promised date or change some other metric. In one or more embodiments, a message 608 may be transmitted to the phase listed in the “who acts on the result” field 606. For example, when the alert level for the output is red or yellow, the message 608 may include a Promised Date, a Need by Date, and the phrase “Talk to the supplier to improve promised date.” In one or more embodiments, the output 610 from the analytic model 600 may be transmitted to a user interface 700, described further below with respect to FIGS. 7 and 8. In the example described in FIGS. 7A-7B herein, the output/response 610 may be a supplier order status per project.

Turning back to the process 300, a digital twin 122 for the current phase in the flow for the object is instantiated in S318. The digital twin mirrors the physical world to the maximum extent possible for each process step and material, including past historical data, current state.

Then in S320, the selected analytic model is executed for the instantiated digital twin 122. In one or more embodiments, the digital twin 122 may provide constraints of the system, and executing the selected analytic for the digital twin 122 may take into account the capability of the twinned system to provide the optimal choice for wherever you are in the process. In one or more embodiments, the digital twin 122 may provide a recommendation to the user to make the optimal choice. In one or more embodiments, the flow module 102 may integrate each of the instantiated digital twins across the system (e.g., the digital twins for two or more projects), to provide an analysis to the user that may include an interaction of the different projects. For example, for a specific item, the analysis may indicate, with respect to a supplier, which supplier the item is coming from, what other items are coming from that supplier, what other suppliers are doing for the company, where the item fits into the schedule for packaging or assembly or other views.

After the selected analytic model 126 is executed, an output response 701 to the request is generated in S322. The output response 710 may include a current phase of the flow for the object based on the executed analytic, in addition to including at least one of a current state for the object with respect to that phase and the project as a whole. The output response 710 may be displayed on a display 132 in S324. In one or more embodiments, the user may change the operation and/or output of one or more phases based on the displayed response. For example, the user may decide to change the order of manufacturing of items for projects if the models show that certain items needed for one project are going to be delayed from a supplier. The user may choose to delay the manufacture of the items needed for that project and instead manufacture items for another project, thus keeping that project on schedule.

FIGS. 7A-7B, for example, provides a user interface 700 showing the output response 701. In this non-exhaustive example, the user may be the person responsible for the packaging phase and preparing the objects for shipment. The user interface 700 may include one or more data display areas 702. As shown herein, for example, there may be a data display area that describes line items by project number and order type 704, a data display area that describes further details about the line items 706, a data display area that allows the user to further filter the data via selection of one or more filters 708 (e.g., quarters, priority, group of project, supplier name, critical item status, engineering status, etc.), an alert key 710 and a data display area that describes a particular selected item 712 in the further details about the line item information display area 706. In one or more embodiments, the data provided in the UI 700 may be extracted into a report form. For example, the report may be a critical item report of a plant layout that includes a nine-month horizon (long term), for a high-level user, and lists the critical item levels for projects whose completion date is the next nine months. Another example of a report may be a Job report of a job layout, with a current quarter horizon (short term), for a low-level user, only for buy items, and that provides a list of project status with completion dates this term, not just the critical items. While the alert key 710 herein shows four alert levels, any suitable number of alert levels may be used. In the example shown herein, this user may be responsible for multiple projects, as indicated by the multiple project numbers 714. As also shown here, each project number 714 may include two or more types 716. Each type 716 may represent a different phase in the flow (e.g., what is the status of WIP, what is the status of planned orders, etc.). Each type 716 may be further analyzed by items in a project 725, as indicated, for example, by each bar 718 in the line items by project number and order type information display area 704. Each bar 718 may be further analyzed to indicate the number of items having a particular alert level status, per the alert key 710. For the first bar 718 in the circled area indicating items in a project, a first portion of the bar 720 includes the number “35,” a second portion of the bar 722 includes the number “4” and a third portion of the bar 724 includes the number “3”. The sum of the numbers in each portion is the number of items in a project. The first portion 720 may be marked commensurate with a green, for example, or other suitable indicator to signal these items are “on time,” the second portion 722 may be marked to signal these items are a certain non-critical number of “days late,” and the third portion 724 may be marked to signal these items are a certain more than non-critical number of days late. While the circled example shows the bar 718 include three portions, the bar may include more than three portions (e.g., project number 1106440, project type PO STD) or less than three portions (e.g., project number 1106640, project type POR). It is noted that by integrating the information across projects, one or more embodiments may provide for: 1. BOM material OTD (by identifying issues with materials coming from certain suppliers), 2. aspects of the phase operation may be optimized (e.g., in this example, packaging external area rental may be optimized), 3. increased monitoring (e.g., increase controllership for localized projects), and a 4. faster execution review with the different phases.

FIGS. 8A-8B provides a user interface 800 showing the output response 801. In this non-exhaustive example, the user has selected several filters 808 to apply to the returned data. As shown herein, in the Active Project filter 808a, the user has selected the “Active project” to select only projects already started and not completed; in the Quarter filter 808b, the user has selected only projects with completion dates in the chosen quarter. It is noted that quarters may be based on completion dates, and that some projects do not have a completion date, so they are not in any quarter. Other filters may include a Supplier yes/no filter, where “Yes” is selected if there is a no empty supplier name field (PO STD and PO BPA) and “No” is selected if there is no supplier name field or it is empty (POR, WIP, Planned Order). Another filter is a Make vs. Buy filter to select buy items, for example. “Make” may refer to WIP and Planned order of type “Make,” and “Buy” may refer to POR, PO STD, PO BPA and Planned order of type “Buy.” Still another filter may be Planned order Make vs. Buy, which may apply only to planned orders, and “Make” refers to Planned orders of type “Make,” while “Buy” refers to planned orders of type “Buy.” Another filter relates to a supplier deviation request (SDR). The process may begin when an external supplier asks for a deviation, and the next step is managed by a supply quality engineer (SQE), who defines if the SDR is minor or major based on the fact that engineering is impacted. In one or more embodiments, if engineering is impacted, the SDR is major, and if not, the SDR is minor. A user may filter and select to see only the PO STD with an open SDR, for example.

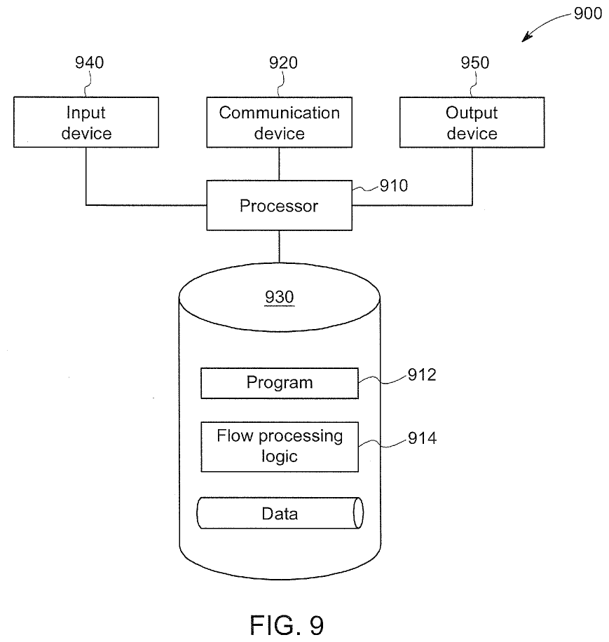

Note the embodiments described herein may be implemented using any number of different hardware configurations. For example, FIG. 9 illustrates a flow platform 900 that may be, for example, associated with the system 100 of FIG. 1. The flow platform 900 comprises a flow processor 910 (“processor”), such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more users. The flow platform 900 further includes an input device 940 (e.g., a mouse and/or keyboard to enter information) and an output device 950 (e.g., to output the outcome of module execution).

The processor 910 also communicates with a memory/storage device 930. The storage device 930 may comprise any appropriate information storage device, including combinations of magnetic storage devices (e.g., a hard disk drive), optical storage devices, mobile telephones, and/or semiconductor memory devices. The storage device 930 may store a program 912 and/or flow processing logic 914 for controlling the processor 910. The processor 910 performs instructions of the programs 912, 914, and thereby operates in accordance with any of the embodiments described herein. For example, the processor 910 may receive data and then may apply the instructions of the programs 912, 914 to determine whether the application content may be distributed.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the platform 900 from another device; or (ii) a software application or module within the platform 900 from another software application, module, or any other source.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors 1010 (FIG. 10). Further, a computer program product can include a computer-readable storage medium with code adapted to be implemented to carry out one or more method steps described herein, including the provision of the system with the distinct software modules.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

1. A system comprising:
a flow module to receive one or more objectives for a flow in the production of an object;
a memory for storing program instructions;
a flow processor, coupled to the memory, and in communication with the flow module and operative to execute program instructions to:
receive a request from a user for a current state of a flow for the object;
retrieve metadata and data from the physical world associated with the object;
determine a current phase in the flow for the object;
select an analytic model to determine the current state of the flow for the object;
instantiate a digital twin for the current phase in the flow for the object;
execute the selected analytic for the instantiated digital twin;
generate a response to the request including the current state of the flow for the object based on the executed analytic; and
display the response on a display.

2. The system of claim 1, wherein the digital twin for each current phase in the flow is integrated into an integrated digital twin for the system.

3. The system of claim 1, wherein the object is an engineer-to-order object.

4. The system of claim 1 wherein the generated response further includes at least one recommendation.

5. The system of claim 1, wherein the current phase in the flow is determined based on data received from at least one of a plurality of databases.

6. The system of claim 1, wherein the analytic model is selected from a catalog of two or more analytic models.

7. The system of claim 1, wherein the analytic model is selected based on the determined current phase in the flow for production of the object.

8. The system of claim 7, wherein the determined current phase is one of: engineering;
sourcing; manufacturing; assembly; packaging and testing.

9. The system of claim 7, wherein the order type is one of: purchase order requisition (POR), work in progress (WIP), standard purchase order (PO STD), and planned orders.

10. A method comprising:
receiving a request from a user for a current state of a flow for the object;
retrieving metadata and data from the physical world associated with the object;
determining a current phase in the flow for the object;
selecting an analytic model to determine the current state of the flow;
instantiating a digital twin for the current phase in the flow;
executing the selected analytic for the instantiated digital twin;
generating a response to the request including the current state of the flow for the object based on the executed analytic; and
displaying the response on a display.

11. The method of claim 10, wherein the object is an engineer-to-order object.

12. The method of claim 10, wherein the generated response further includes at least one recommendation.

13. The method of claim 10, wherein the current phase in the flow is determined based on data received from at least one of a plurality of databases.

14. The method of claim 10, wherein the analytic model is selected from a catalog of two or more analytic models.

15. The method of claim 10, wherein the analytic model is selected based on the determined current phase in the flow for production of the object.

16. The method of claim 15, wherein the determined current phase is one of: engineering;
sourcing; manufacturing; assembly; packaging and testing.

17. The method of claim 15, wherein the order type is one of: purchase order requisition (POR), work in progress (WIP), standard purchase order (PO STD), blanket purchase agreement purchase order (PO BPA), and planned orders.

18. A non-transitory computer-readable medium storing instructions that, when executed by a computer processor, cause the computer processor to perform a method comprising:
receiving a request from a user for a current state of a flow for the object;
retrieving metadata associated with the object;
determining a current phase in the flow for the object;
selecting an analytic model to determine the current state of the flow;
instantiating a digital twin for the current phase in the flow;
executing the selected analytic for the instantiated digital twin;
generating a response to the request including the current state of the flow for the object based on the executed analytic; and
displaying the response on a display.

19. The medium of claim 18, wherein the object is an engineer-to-order object.

20. The medium of claim 18 wherein the analytic model is selected based on the determined current phase in the flow for production of the object in a context of an order type.
